(19) United States
(12) Patent Application Publication
(10) Pub. No.: US 2007/0121879 A1
(43) Pub. Date: May 31, 2007

(54) Enhanced directory assistance system with ENUM based features

(76) Inventors: Faith McGary, Bethlehem, PA (US); Michael Bates, Bethlehem, PA (US)

Correspondence Address: SOFER & HAROUN LLP., 317 MADISON AVENUE, SUITE 910, NEW YORK, NY, 10017, US

(21) Appl. No.: 11/494,262

(22) Filed: Jul. 27, 2006

Related U.S. Application Data
(60) Provisional application No. 60/703,510, filed on Jul. 28, 2005.

(51) Int. Cl. H04M 3/42

(52) U.S. Cl. 379/218.01

(57) ABSTRACT

An ENUM services system includes a server module configured to support an ENUM account for a subscriber. The ENUM account has a single incoming contact number for the subscriber and one or more preferred outbound contact addresses, such that when a caller calls the single incoming contact number the call is connected to the subscriber on one or more preferred outbound contact addresses. A supplemental ENUM services platform is coupled to the server module to allow the subscriber of the ENUM account to map additional internet ready devices to the ENUM account, so that the subscriber may contact the system using the ENUM account to remotely control the additional internet ready devices.

### RELATED APPLICATION

This application is related to and claims the benefit of priority from U.S. Provisional Patent Application No. 60/703,510, filed on Jul. 28, 2005, the entirety of which is incorporated herein by reference.

### FIELD OF THE INVENTION

The present invention relates to the field of directory assistance. More particularly, the present invention relates to directory assistance for use with ENUM applications.

### BACKGROUND OF THE INVENTION

The average business card today contains an ever increasing amount of contact information for a person to remember. A typical business card for example may contain a telephone number, a pager number, a fax number, a VoIP address and an e-mail address.

Combining the need to simplify the storage and addressing of contact information for individuals having multiple devices and address, with the new advances in IP packet-switched telephone networks, ENUM or Electronic Number has been developed. ENUM is a telephone mapping protocol developed by the Internet Engineering Task Force (IETF) that employs an existing telephone number or an newly assigned number (similar in size to a telephone number) to acces various devices of a user. For example, it enables what would traditionally be circuit-switched traffic to be carried along a packet-switched network, because it may match a circuit address (a telephone number) to a network address (a URL). Because this traffic is not restricted to traveling along a dedicated line, flow of traffic becomes more efficient and much more flexible. The ENUM protocol allows users to receive calls originating from other VoIP telephones or from PSTN phones, as well as from other digital devices seamlessly.

However, with ENUM being a packet switched communication there is an unfulfilled potential for additional services. Furthermore, even if an ENUM exists for an individual or business, there is currently no way to know this ENUM without them directly providing it to a caller.

### OBJECTS AND SUMMARY

It is a first object of the present invention to provide a system for coupling additional data to a traditional ENUM account for a subscriber. Thus, additional applications may be coupled to a subscriber's ENUM in order to provide additional functionality to the number. These additional features may include attachment of additional account information by basic contact numbers, such as banking or e-commerce applications. Furthermore, the present invention, utilizing the fact that ENUM is based on IP addressing, may attach any devices, such as home computers, digital TV's DVD/burners etc. such that the subscriber, using their ENUM account, is enabled to access any Internet device that is associated with their account using the single ENUM number.

It is a second object of the present invention to provide enhanced directory assistance to a caller, allowing them to request and be connected to a subscriber's ENUM of a desired party.

To this end, the present invention is directed to an ENUM services system includes a server module configured to support an ENUM account for a subscriber. The ENUM account has a single incoming contact number for the subscriber and one or more preferred outbound contact addresses, such that when a caller calls the single incoming contact number the call is connected to the subscriber on one or more preferred outbound contact addresses. A supplemental ENUM services platform is coupled to the server module to allow the subscriber of the ENUM account to map additional internet ready devices to the ENUM account, so that the subscriber may contact the system using the ENUM account to remotely control the additional internet ready devices.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a block diagram of an ENUM services system, in accordance with one embodiment of the present invention;

FIG. 2 is a basic ENUM account profile for the ENUM services system of FIG. 1, in accordance with one embodiment of the present invention;

FIG. 3 illustrates a typical call from a caller to an ENUM subscriber, from the ENUM services system from FIG. 1, in accordance with one embodiment of the present invention;

FIG. 4 is a domain tree illustration for an ENUM, in accordance with one embodiment of the present invention;

FIG. 5, is a block diagram of the ENUM services system from FIG. 1, with coupled ENUM services platform, in accordance with one embodiment of the present invention;

FIG. 6 is an ENUM services record stored in ENUM services platform from FIG. 5, in accordance with one embodiment of the present invention;

FIG. 7 is flow diagram of a subscriber accessing additional devices via the ENUM services platform from FIG. 5, in accordance with one embodiment of the present invention;

FIG. 8 is flow diagram of a subscriber accessing additional devices via the ENUM services platform from FIG. 5, in accordance with another embodiment of the present invention;

FIG. 9 is flow diagram of a subscriber accessing additional devices via the ENUM services platform from FIG. 5, in accordance with another embodiment of the present invention;

FIG. 10 is a block diagram of the ENUM Directory Assistance platform system, in accordance with one embodiment of the present invention; and

FIG. 11 is a flow chart illustrating a directory assistance call requesting the ENUM of a subscriber, in accordance with one embodiment of the present invention.

### DETAILED DESCRIPTION

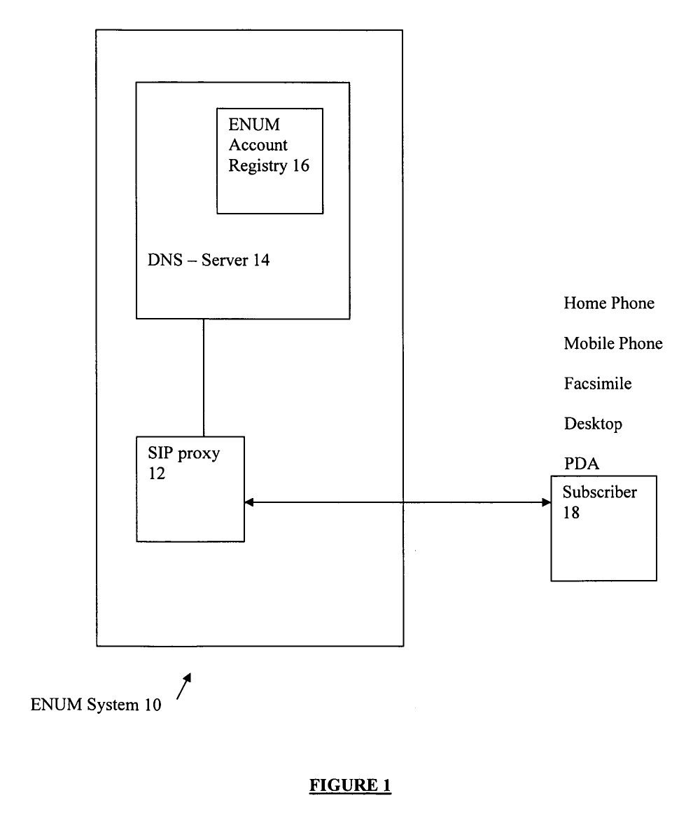

In one embodiment of the present invention, as illustrated in FIG. 1, ENUM services system 10 employs a traditional SIP (Session Initiation Protocol) proxy 12 and a DNS (Domain Name System) server 14. SIP proxy is configured to receive incoming communications to system 10, and DNS server 14 handles the incoming calls as outlined in more detail below. DNS server 14 further maintains an ENUM account registry 16 for storing ENUM account information for a plurality of subscribers 18, who maintain ENUM accounts with system 10.

Subscriber 18 first contacts system 10 and establishes an ENUM account. This is accomplished by having system 10 assign a contact telephone number to subscriber 18. Typically, the contact telephone number is simply a standard 10 digit telephone number, either a pre-existing number or newly created number, which when dialed by a caller 20 connects the outgoing call to subscriber 18 in a manner prescribed in the account. It is understood that system 10 is equally applicable to (800), International and private network ENUMs.

In setting up the account, after the contact telephone number is assigned, subscriber 18 registers one or more contacts addresses (devices) to the ENUM, such as mobile telephones, land line telephones, fax machines, voice mail accounts, IM (Instant Message) or e-mail accounts, VoIP phone addresses, PDA's. For example, subscriber 10 might wish to register a first mobile telephone number to the ENUM account, a second home telephone, a third VoIP telephone, an e-mail address and finally a fax machine all accessible to a caller 20 when they enter the single contact phone number of subscriber 18. The information for the registered contact addressed are saved in what are called NAPTR (Naming Authority Pointer) Resource Records in ENUM account registry 16. It is understood that any connectivity address or device, voice or text, may be registered to the ENUM account by subscriber 18.

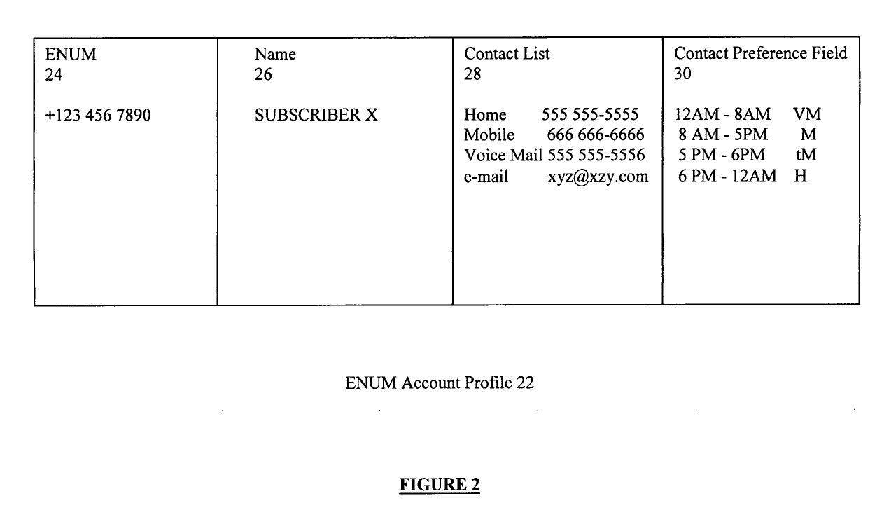

As illustrated in FIG. 2, a typical ENUM account profile 22 is shown. ENUM account profile 22 maintains a contact telephone number field 24 identifying the number contact for the account. A name field 26, stores the name of subscriber 18 attached to profile 22. A contact list field 28 lists the registered contact addresses or devices for the account. In the illustrated Example, subscriber 18 has registered three contact devices and an e-mail address:

Home Phone 555 555-5555

Cell Phone 666 666-6666

Voice Mail system 555 555-5556

E-MAIL xyz@xyz.com

Additionally, in a contact address preferences field 30, subscriber 18 has identified four time slots for different incoming call destinations for calls placed to the contact telephone number stored in contact telephone number field 24. Calls from 12 AM-8 AM are directed to voice mail; calls from 8 AM-5 PM are directed to the mobile number; calls from 5 PM-6 PM are converted to text and sent to the mobile number and finally calls from 6 PM-12 AM are sent to the home phone. Thus, by giving out a single ENUM to potential callers 20, subscriber 18 may be reached in their preferred format as per their settings in ENUM account profile 22.

It is understood that as a second option, in addition to preferences field 30 setting up the exact method of connection to subscriber 18, it may in turn, if the relevant device support such a feature, return a list of options to caller 20. For example, subscriber 18 may for a certain time frame set their contact address preferences field 30 to allow caller 20 to select between connection by text message or mobile telephone call. This would allow some flexibility to caller 20, to set the connection mode to one that is appropriate for the content of the message but leaves ultimate control with subscriber 18.

For the purposes of illustration the present description contemplates a caller 20 making a voice communication to subscriber 18 who is receiving the call in a voice telephony format. However, it is understood caller 20 may be generating an e-mail or text sent to the contact telephone number and subscriber 18 may receive such in an electronic format on their end (e-mail, SMS, facsimile, etc . . . ). Likewise, the invention further contemplates that caller 20 may be operating in voice or text and subscriber 18 may be receiving in the opposite format (eg caller sends in voice and subscriber receives in text and vise versa). In such instances, system 10 contemplates a speech-to-text/text-to-speech module 15 to support any number of connectivity options, including any conversions from speech to text and text to speech, video to text etc . . . .

Furthermore, any number of additional timing options for contact address preferences field 30 can be used, including dual communications for the same time slot. For example, during a pre-defined time of day a call to the contact number of the ENUM account of subscriber 18 may result in the call being forwarded to their mobile telephone as well as being simultaneously converted to text and sent to an e-mail account.

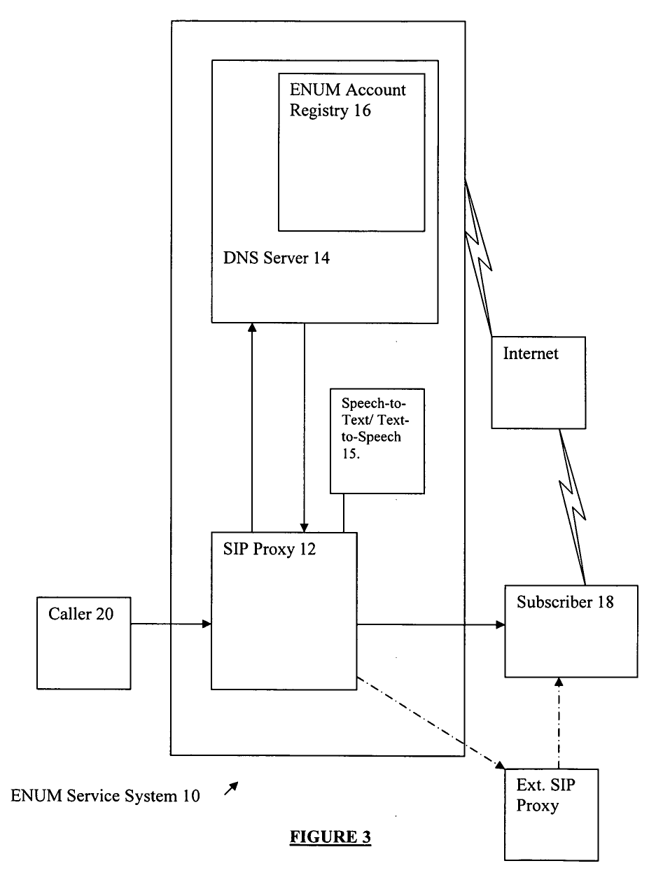

Once ENUM account profile 22 is set up, a caller 20 may place a call to subscriber 18 by dialing the contact telephone number. FIG. 3 illustrates a typical ENUM call flow to subscriber 18 from caller 20.

In order to place an ENUM call, caller 20 dials the contact telephone number associated with the ENUM account as it would normally be dialed. For example, the caller dials the number 1-202-555-1234, the contact number from profile 22 of subscriber 18. In cases where caller 20 dials less than a complete contact number (for example, a caller 20 within the 202 area code might leave off the “1,” or a caller 20 within an office system might dial only “1234”), it is contemplated the in network equipment in system 10 or other external network equipment of caller 20 recreates the complete form of the number for use with ENUM.

Next, the contact number is translated into an ENUM internet address that can be used by DNS server 14. Because this internet address is based on a complete international telephone number (in this example, +1-202-555-1234), a unique Internet address exists for every unique ENUM account. To determine if the contact number and corresponding Internet address are registered in ENUM account registry 14, the telephone number is translated in the following manner:

1. In this example, the contact telephone is 1-202-555-1234. This contact telephone number is first stored as +1-202-555-1234. “1” is the country code for the United States, Canada, and the seventeen other countries that make up the North American Numbering Plan (NANP). The “+” indicates that the number is a complete, international telephone number, known as an E.164 number. E.164 is the name of the international telephone numbering plan administered by the International Telecommunication Union (ITU).

2. All characters are removed except for the digits. Example: 12025551234

3. The order of the digits is reversed. Example: 43215552021

4. Dots are placed between each digit. Example: 4.3.2.1.5.5.5.2.0.2.1

5. The domain “e164.arpa” is appended to the end. Example: 4.3.2.1.5.5.5.2.0.2.1.e164.arpa

E164.arpa has been proposed as the DNS domain for use with ENUM. This designation may change as a result of ongoing discussions between the ITU, the Internet Engineering Task Force (IETF), and other international organizations involved with ENUM. In the event that the international community chooses a different ENUM domain, it is contemplated that the system and method discussed herein is equally applicable to the changed domain.

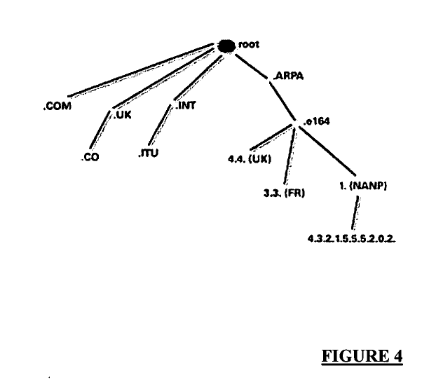

The .arpa domain is under the administrative management of the Internet Architecture Board (IAB). It has been designated specifically for Internet infrastructure purposes. ENUM is considered appropriate as an infrastructure application because it provides a set of DNS-based resource directories, referenced by phone number, for use by various ENUM-enabled application subscribers 18. The contact telephone number is reversed because DNS, such as at DNS server 14 reads addresses from right to left, from the highest level to the lowest level. In this case, a DNS lookup would start at the .arpa domain, and it would continue with .e164. Under e164 it would look for the “1” as the country code for the North American Numbering Plan. It would then look up each succeeding digit in the telephone number until the address is fully resolved. As illustrated in FIG. 4, if DNS begins to search under arpa, it can then search under .e164, followed by the country code and reversed telephone number. DNS cannot, however, look under .int once it has begun to look in the arpa tree. This diagram shows a number of branches, with top-level domains of .com, .uk, int, and .arpa.

Once the ENUM of subscriber 18 is translated into an Internet address, a DNS query is issued on the domain, as previously described. One of two things can happen.

If an authoritative name server is found, such as DNS server 14 of system 10, the dialed contact telephone number retrieves the relevant NAPTR Resource Records and the call proceed according to profile 22 of subscriber 18, continuing to the desired registered communication address according to address preferences field 30.

It is understood that for subscribers 18 their name server is DNS server 14. In order to determine if the dialed number is a contact number of an ENUM account in account profile registry 16, the SIP proxy of caller 20 pings registry 16. In the case of callers 20 who use system 10 as their provider this simply entails SIP proxy 12 contacting account registry 16. However, if caller 20 is from another provider that supports ENUM connections, then their SIP proxy may, using the ENUM created from the contact telephone number, directly contact account registry 16 of DNS-sever 14 to obtain profile 22.

Depending on the preferences subscriber 18 contained in profile 22 the telephone call may be conducted entirely over the Internet as a VoIP call, without using the Public Switched Telephone Network or vise versa.

2. If an authoritative name server cannot be found, DNS server 14 returns a 404 Not Found error to the VoIP enabled telephone of caller 20, and, if possible, a connection to the PSTN is opened, and the call is routed conventionally, as it is assumed the dialed number is not an ENUM.

Returning to FIG. 3, subscriber 18 has registered for ENUM services with system 10 using the Session Initiation Protocol (SIP) address sip:name@domain.com of SIP server 12. A query based on the ENUM dialed by caller 20 is sent to DNS-server 14, which returns the correct SIP address and SIP proxy 12 sets up the call accordingly.

It is understood that the above described process is only one of a number of ways that ENUM can be used to set up a call between caller 20 and subscriber 18. The flow of information remains the same regardless of whether additional applications such as speech to text (call to e-mail, call to fax, call to text message). Furthermore, it is contemplated that if caller 20 is outside of network, or if subscriber 18 uses a different VoIP provider, SIP proxy 12 of system 10 may need to contact an additional one or more SIP proxy's on other networks to ensure call connection.

As identified above, ENUM supported by system 10 is invisible to both subscriber 18 and caller 20 from a telephony standpoint. The VoIP network of system 10 is accessible, either by use of an Internet-enabled telephone, or from a standard telephone that has access to either a soft switch (a switch that allows access to the IP network) or a circuit switch that has had IP-enabling software added to it. It is important to note that a call placed from an Internet-enabled telephone is also able to reach the Public Switched Telephone Network if the number dialed cannot be found on the Internet (is not a registered ENUM).

As outlined above, the voice application of ENUM in system 10 provides advantageous connectivity for subscriber 18. Along the same line as telephone usage however, faxing becomes flexible, and as efficient. In fact, for fax applications it is even more logical and much more efficient to use the IP network of system 10.

An Internet-enabled fax machine of subscriber 18 (or a fax machine on an Internet-enabled circuit-switched network) has the same basic functionality as an Internet-enabled telephone. As long as subscriber 18 has set up their contact list field 28 and contact preferences field 30 of ENUM profile 22 to register for fax services, another Internet-enabled fax machine is able to reach it using the ENUM. Otherwise, that fax machine remains reachable via traditional PSTN.

Furthermore utilizing the above described system 10, the use of e-mail becomes more feasible in accordance with the invention. Rather than typing in an email address, caller 20 may type the contact telephone number of subscriber 18 which is mapped to the ENUM account of subscriber 18. If that ENUM account has been mapped to an e-mail address in profile 22, the mail is sent, and the address lookup is invisible to both sender 20 and subscriber 18. In this case, sender 20 would first type in the complete, contact telephone number of subscriber 18.

ENUM system 10 may further be configured to enable traditional call-forwarding, follow-me, and do-not disturb functions, as well as new features that merge Internet applications with video and voice communications. Using applications that use SIP resources, a subscriber 18 using a telephone connection with their computer could be prompted on that computer that another call is arriving. Subscriber 18 could make a selection on the computer to either end the dialup session, answer the phone, forward the call to another number, or send caller 20 to voice mail. As another example, subscriber 18 could transfer caller 20 to a web page instead of to another phone. In this case, the call would end, and the web browser of subscriber 18 would open the new page. ENUM numbers are mapped with identifiers such as: First Name, Last, Name, Address, Credit Card Data, Personal Information.

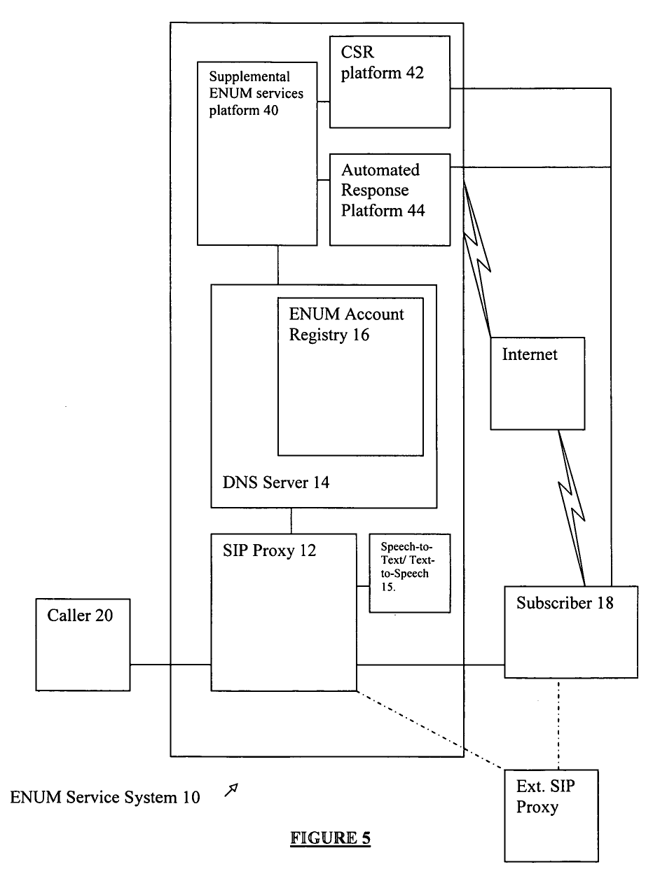

In another embodiment of the present invention, illustrated in FIG. 5, ENUM services system 10 further includes a supplemental ENUM services platform 40 coupled to DNS server 14 configured to allow subscriber 18 to register additional internet enabled devices to profile 22 beyond simple communication addresses.

Thus, in one embodiment of the present invention, as set forth in the list below, supplemental ENUM services platform 40 of system 10 provides mapping and control services to a number of additional items owned or controlled by subscriber 18 via their ENUM. Also, supplemental ENUM services platform 40 allows subscriber 18 to access their ENUM account, and add additional information such as financial (banking) information as well as to connect and map certain IP address capable devices to the account. Thus, using only their ENUM, subscriber 18 may control mapped devices also via contact through their ENUM and handle e-commerce transactions

In one embodiment of the present invention, below is a list of the various features and devices that may be mapped or enabled through the ENUM account for subscriber 18 via the present invention:
1. Cable TV
2. Satellite TV
3. Operator Services (non-directory assistance, such as reservations or directions)
4. Directory Assistance (traditional contact look-up)
5. Retail Operations (on-line or telephonic commerce)
6. Banking Features (telephonic or online account access and bill payments)
7. MVNO (Mobile Virtual Network Operator) (connection to non-network equipment owning virtual operators for additional services such as music downloads)
8. Internet/Digital formats
9. Communication Transport (cross-protocol communications)
10. Presence based communications
11. Enhanced CRM (Customer Relationship Management) integration with telephony systems
12. Episode information to screen pops
13. Interactive Voice Response Systems
14. Self Service Adoption (unattended payment)
15. Customer Enabling Environments
16. Biometric Authentication (storage of biometric security data for accessing own ENUM account or other secure features)
17. Real time ordering system for NVOD (Near Video On Demand)
18. Micro Transaction Processing (small on-line payments
19. PABX to CRMs (Private Automatic Branch Exchange) (Customer Relations Management)

Thus in one embodiment, system 10 of the present invention allows subscriber 18 to map additional IP enabled devices to their ENUM account so that they may gain additional remote operating capabilities, using only their ENUM. For example, subscriber 18 may map an IP enabled DVD player to their account or possibly their digital cable account as discussed in more detail below.

Furthermore, in addition to mapping devices to their ENUM account, subscriber 18 may also attach financial data such as financial account information, or other similar personal information. This information may typically include information such as bank account numbers and passwords.

In either case, whether adding personal/account information or device IP addresses to the ENUM account, such a process is typically handled on-line where subscriber 18 accesses system 10 by web. Alternatively, subscriber 18 may generate and modify the account verbally, either with the assistance of a live customer service representative 42 or with an automated IVR module 44 within system 10 coupled to supplemental ENUM services platform 40.

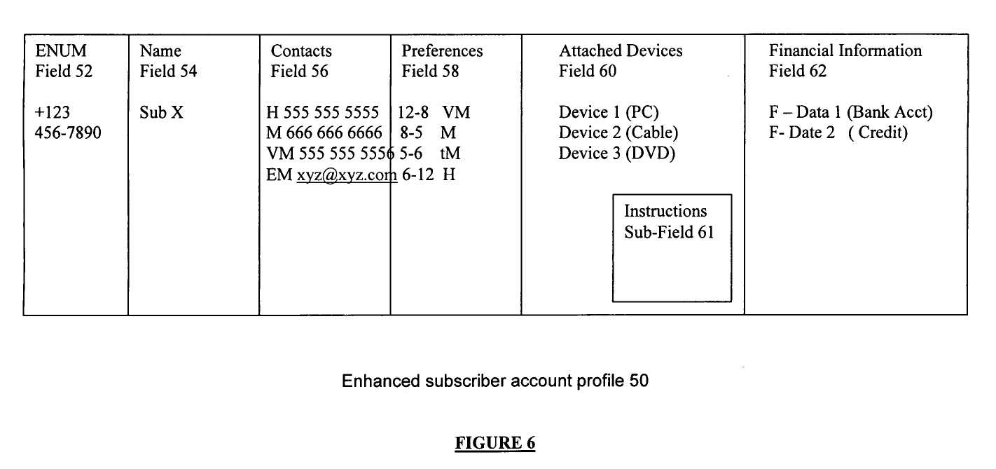

In one embodiment of the present invention as illustrated in FIG. 6, an enhanced subscriber account profile 50 is shown having similar fields to standard profile 22. For example, enhanced subscriber account profile 50 maintains an ENUM field 52 identifying the contact telephone number for the account. A name field 54, that stores the name of subscriber 18 attached to profile 50. A contact list field 56 lists the registered contact addresses for the account. Similar to profile 22, in the illustrated example in FIG. 6, subscriber 18 has registered four contact devices/addresses:

Home Phone 555 555-5555

Cell Phone 666 666-6666

Voice Mail system 555 555-5556

e-mail xyz@xzy.com

Additionally, in a contact address preferences field 58, subscriber 18 has identified four time slots for different incoming call destinations for calls placed to the ENUM in contact preferences field 56.

However, enhanced subscriber account profile 50 also maintains attached devices field 60 with supplemental device instructions sub-field 61 and financial data field 62. Attached devices field 60 is configured to store a list of attached internet capable devices of subscriber 18 that are associated with their ENUM account for remote access/control. Supplemental device instructions sub-field 61 includes any pre-configured instructions and associated data (such as passwords etc . . . ) that are associated with device included in field 60. Financial data field 62 is configured to store the financial data (credit card, bank account information, etc . . . ) of subscriber 18.

Turning now to an exemplary process for attaching internet enabled devices to the ENUM account of subscriber 18 at system 10, subscriber 18 may access supplemental ENUM services platform 40 of system 10 in order to implement an ENUM handling of their IP address capable devices.

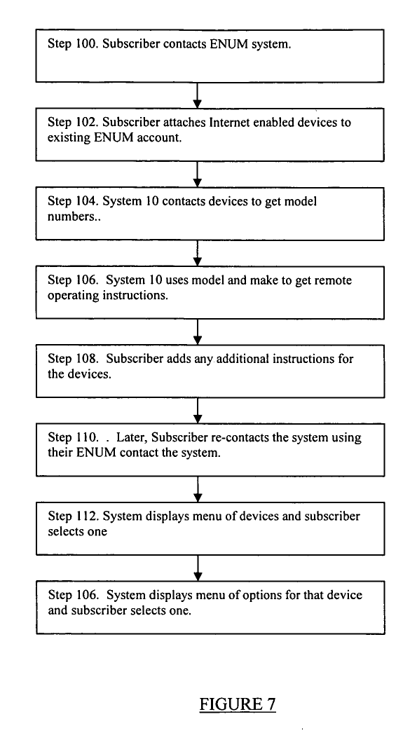

For example, as illustrated in flow chart FIG. 7, if subscriber 18 has an ENUM account, then at step 100, they may contact either the live customer service representative 42 or an automated module 44 and retrieve their ENUM account and associated enhanced subscriber account profile 50.

Next, at step 102, subscriber 18 may add/map any number of IP enable devices as described above to attached devices field 60. For example, in the case of device 3 from profile 50 subscriber may wish to map their DVD player to their ENUM account. This entails subscriber 18 locating a device identifying number on the DVD player. For example, internet enabled devices include a MAC address (Media Access Control) which uniquely identifies the device. Alternatively the IP address being used to connect the device to the internet may also be used. Although this does not identify the device itself, it at least defines the address where the device is located.

At step 104, after user maps all of the desired devices to profile 50, system 10 contacts the device to make sure the connection is correct and then proceeds to obtain some operating instructions for the device. In the present Example, subscriber 18 has mapped a DVD player to ENUM account. So for this device, system 10 may ping the MAC address of IP address of this DVD player. If the MAC is used system 10 could then identify the make and model immediately, and if the IP address is used, system 10 may need to establish the make and model of the DVD player through a brief identification communication.

Next, at step 106, system 10, knowing the make and model of the DVD player, contacts the manufacturer or other information source and obtains the contact and control instructions. It is understood that system 10 may simply store the directions for all devices it supports remote control for or it may contact the manufacturer for each device, depending on which arrangement works better for the devices being mapped. Alternatively, for devices which no instructions can be found, subscriber 18 may provide them to system 10 themselves. Regardless of how they are obtained, the remote operating instructions are stored in instructions sub-field 61.

At step 108, subscriber 18 then may add any additional settings or pre-identified instructions to instructions sub-field 61. Such additional instructions may include but are not limited to modified instructions overtop of the pre-set manufacture instructions and scheduled automatic remote operations such as “Record channel X at 10:00 PM every Monday.”

Later, at step 110, subscriber reconnects to their account with system 10 by dialing the contact number for their ENUM account, similar to how voice mail is accessed on standard cellular telephones. At step 112, system 10 recognizes subscriber 10, and presents a menu of devices based on all of the devices in attached devices field 60. In the present Example, subscriber 18 could choose from their PC, their DVD player or their Cable television box.

Assuming that subscriber 18 selects to proceed on the DVD player, then at step 114, system 10 presents a second menu to subscriber 18 with all of the available remote control options. For example, after system 10 obtains the remote operating instructions as noted above in step 106, system 10 has a list of supported operations. This list is displayed as a menu to subscriber 18 including such options as record channel, set up a scheduled recordation, turn off machine, copy disk to another location etc . . . . Such menu and subscriber selections can be handled through either automated platform 44 or live operator 42. An exemplary instructions may request that DVD recorder begin recording channel “#2 at 10:00 PM.”

The Examples of different IP enabled devices that can be controlled through the ENUM account with system 10 using supplemental ENUM services platform 40 are too numerous to recount in detail. It is understood that any similar ENUM account which allows mapping and control of IP enable devices owned by the ENUM subscriber, are also within the contemplation of the preset invention.

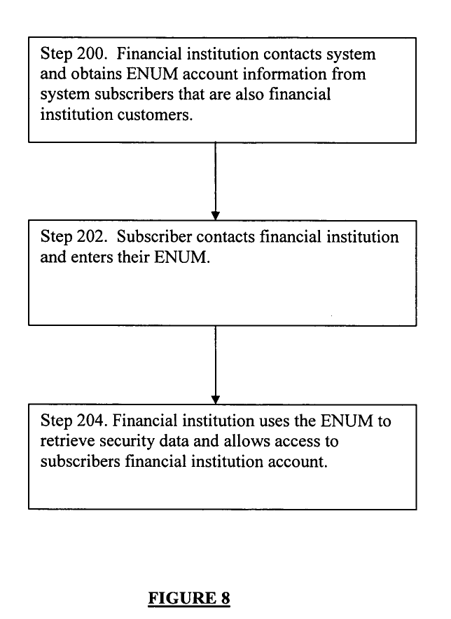

In another embodiment of the present invention, third parties may utilize the financial information of subscriber 18 stored in financial data field 62. For example, as illustrated in flow chart FIG. 8, at a first step 200, a financial institute such as a bank may either purchase the ENUM registry of profiles 50 from system 10 of the present invention (assuming that it only purchases those profiles 50 that include affiliated data in financial data field 62 from that institution, not the complete listing set of system 10) or it may alternatively, simply link to ENUM profiles 50 of system 10. In either event this gives the bank access not only to the ENUM account of subscriber 18 but also to the attached information in the financial data field 62 of ENUM profile 50 for its customers. For example, if system 10 maintains some number of subscribers 18 who bank at Bank ABC, and those users maintain their financial data in financial data field 62, then Bank ABC will have access to each of the ENUM accounts for those subscribers 18. Thus qualifying financial institutions maintain a list of subscribers 18 who have accounts with their bank.

Such an arrangement allows cross services promotions, encouraging subscribers 18 to open accounts at banks which allow access using their ENUM account information. The advantageous functions of such an arrangement are evident because banks typically use passwords or other such identifiers, as well as account numbers in order for a person to access and work with their accounts. Using the present invention, a bank may simply add an additional layer to their voice command structure requesting an ENUM from the caller.

Thus, at a second step 202, if the caller is an ENUM subscriber 18 to system 10 and maintains their financial information (including passwords, and account identifiers) in financial data field 62 with system 10, the subscriber can enter their contact telephone number identifying their ENUM account. In turn, at step 204, the bank then employs the data from ENUM profile 50 to allow subscriber 18 to access their account with the bank. For added security, it is understood that additional security data may be stored in the ENUM account such as biometric or other personal identifying data to be verified when the call to the institution is made. Such an arrangement reduces the amount of input required by subscriber 18 to access their bank accounts each time they connect to the banking institution, by storing all the necessary security and personal identification information with their ENUM account.

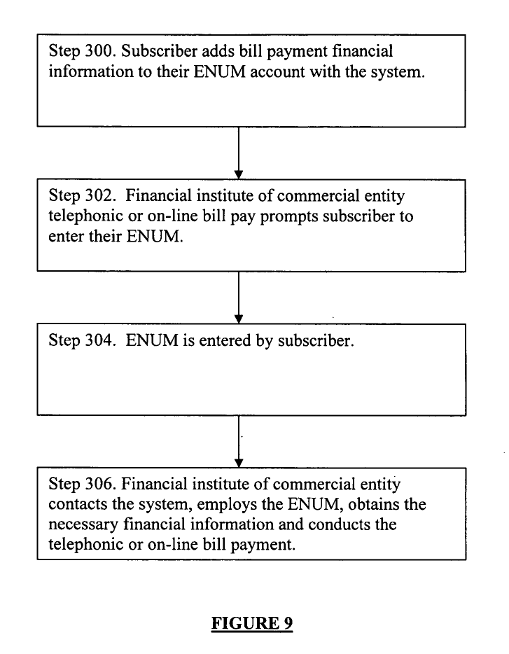

In another embodiment of the present invention, as illustrated in flow chart FIG. 9, using the same ENUM account in system 10 and the related financial data in financial data field 62, a bank or other commercial institution may offer subscriber 18 additional services related to their financial information. For example, in step 300, if subscriber 18 adds a credit card account information as well as their electric bill account number to financial data field 62 of profile 50 for their ENUM account.

At step 302, a financial institution or commercial entity offers the ability to pay bills online using the account info from the financial data field 62 of ENUM profile 50 by adding an additional layer to their voice command structure requesting an ENUM from the caller. At step 304, subscriber 18 enters their ENUM when prompted and at step 306, the financial or commercial institute, after verifying the any security data from the ENUM account, accesses financial data field 62 of ENUM profile 50 and affects payment of the desired bill.

Such an arrangement allows flexibility when bills are paid electronically as opposed to the more rigid timing of money transfers under current electronic bill payment methods offered directly through the utilities themselves.

Again the Examples of different banking services that can be controlled through the ENUM account with system 10 using supplemental ENUM services platform 40 are too numerous to recount in detail. It is understood that any similar ENUM account which allows storage and use of financial data in addition to traditional ENUM functions are also within the contemplation of the preset invention.

In another embodiment of the present invention, system 10 further supports directory assistance for callers 20 seeking the ENUM contact telephone of another person. Currently, although ENUM is available to subscribers 18 of system 10 as well as through other services, there is no way for caller 20 to get the ENUM contact number of a subscriber 18 unless it is given to them.

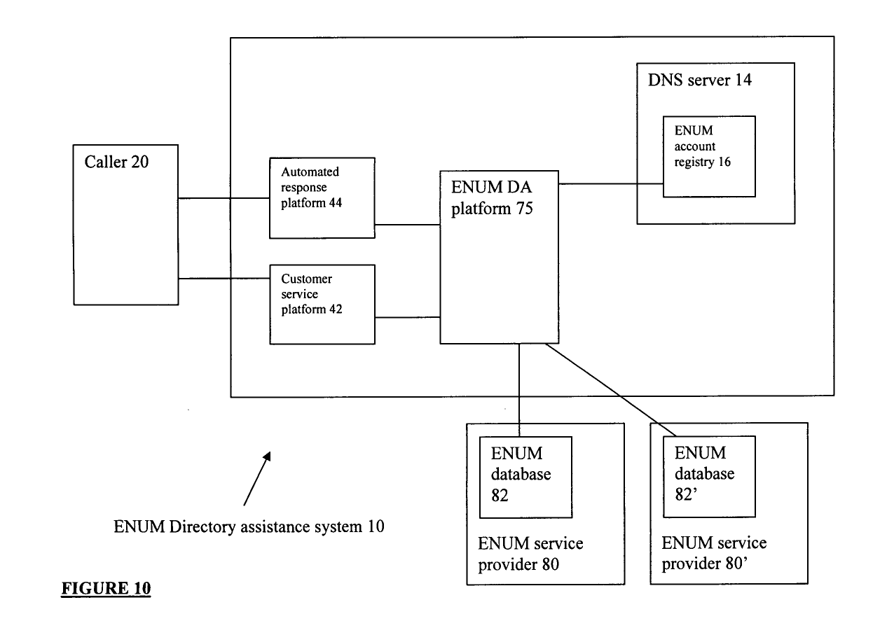

In one embodiment of the present invention as illustrated in FIG. 10, system 10 acts as a Directory Assistance (DA) platform for providing ENUM's to callers 20. Callers 20 contact system 10 through traditional methods, either electronic (text) or telephonic. Electronic communications to system 10 from caller 20 may come in the form of e-mail, HTTP, SMS, IM or any other type of electronic format. Telephonic communications to system 10 may come via VoIP, mobile or traditional land-line telephones. Regardless of format, system 10 contemplates receiving the incoming request at either automated response platform 44 or. Customer Service Representative platform 42, if a live operator is required. Both automated platform 44 and live operator platform 42 can handle both electronic and telephonic calls from caller 20.

Queries to system 10 for the ENUM contact number of an individual are handled with help of DA query platform 75 and are searched against both ENUM account registry 16 of DNS server 14 as well as against other ENUM provider 80 ENUM databases 82. Thus, for example, if caller 20 is seeking the ENUM contact number of an individual and they happen to have their ENUM account supported by system 10 then that requested ENUM contact telephone number can be retrieved from ENUM account registry 16. However, if requested ENUM contact telephone number is from a user who is not a subscriber to system 10, but instead has their ENUM supported by third party ENUM provider 80, then DA query platform 75 of system 10 may look up the data directly through connections with ENUM databases 82 of providers 80 or any other third party repository of ENUM account data.

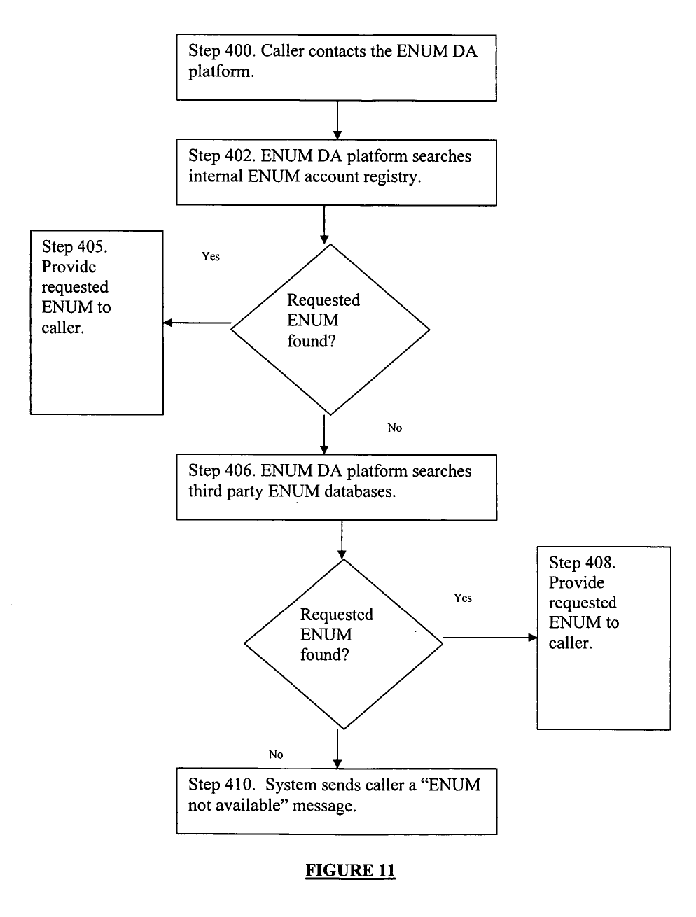

As illustrated in flow chart FIG. 11 in a first step 400, caller 20 contacts ENUM DA platform system 10 and provides a search request to either automated platform 44 or live operator platform 42. Next, at step 402, DA query platform 75 receives search request from automated platform 44 or live operator platform 42 and checks against ENUM account registry 16 to see if the desired ENUM contact telephone number is of a subscriber 18 of system 10. If yes, then at step 404 it is provided to caller 20 as requested. If not, then at step 406 DA query platform 75 checks against other ENUM databases 82 or any other external repository of ENUM data. If a match is found, at step 408 the requested data is sent to caller 20. If the requested ENUM data is not found then at step 410, system 10 sends caller 20 a response that the requested data is not available. This flow is intended only as an example, an alternative flow may include a search of both ENUM account registry 16 and third party ENUM databases 82 simultaneously.

It is understood that the above description of DA services for ENUM is for exemplary purposes only. Any additional directory assistance features including enhanced delivery methods, enhanced customer service methods, priority queuing, or any other known directory assistance enhancements used in conjunction with the above described ENUM DA queries are within the contemplation of the present invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1) An ENUM services system comprising:
a server module configured to support an ENUM account for a subscriber, said ENUM account having a single incoming contact number for said subscriber and one or more preferred outbound contact addresses, such that when a caller calls said single incoming contact number said call is connected to said subscriber on one or more preferred outbound contact addresses; and
a supplemental ENUM services platform coupled to said server module configured to allow said subscriber of said ENUM account to map additional internet ready devices to said ENUM account, such that said subscriber may contact said system using said ENUM account to remotely control said additional internet ready devices.

2) The ENUM services system as claimed in claim 1, further comprising an automated response module and live operator module allowing said subscriber to contact said system for mapping said internet ready devices to said ENUM account.

3) The ENUM services system as claimed in claim 1, wherein said subscriber contacts said system via the internet for mapping said internet ready devices to said ENUM account.

4) The ENUM services system as claimed in claim 1, wherein said mapped devices are addressed using either one of the group consisting of MAC address and IP address.

5) The ENUM services system as claimed in claim 1, wherein said system identifies said mapped devices and obtains instructions for remote operation of said devices.

6) The ENUM services system as claimed in claim 1, wherein for said ENUM account said system maintains an enhanced ENUM account profile, for storing information related to said mapped devices.

7) The ENUM services system as claimed in claim 6, wherein when said subscriber contacts said system for remote control of said mapped devices said system presents said subscriber with a menu of mapped devices stored in said enhanced ENUM account profile.

8) The ENUM services system as claimed in claim 7, wherein when said subscriber contacts said system for remote control of said mapped devices and selects a device from the provided menu of mapped devices, said system presents said subscriber with a menu of remote applications that may be carried out for said selected mapped device.

9) The ENUM services system as claimed in claim 8, wherein said enhanced ENUM account profile includes an instructions sub-field that includes pre-defined instructions and password/account information necessary for remotely controlling said attached devices.

10) An ENUM services system comprising:
a server module configured to support an ENUM account for a subscriber, said ENUM account having a single incoming contact number for said subscriber and one or more preferred outbound contact addresses different than said single incoming contact number, such that when a caller calls said single incoming contact number said call is connected to said subscriber on one or more preferred outbound contact addresses different than said single incoming contact number; and
a supplemental ENUM services platform coupled to said server module configured to allow said subscriber of said ENUM account to couple financial data to said ENUM account, such that said subscriber may conduct financial transactions using only said single incoming contact number.

11) The ENUM services system as claimed in claim 10, further comprising an automated response module and live operator module allowing said subscriber to contact said system for adding said financial data to said ENUM account.

12) The ENUM services system as claimed in claim 10, wherein said subscriber contacts said system via the internet for adding said financial data to said ENUM account.

13) The ENUM services system as claimed in claim 10, wherein said financial data coupled to said ENUM account includes security means.

14) The ENUM services system as claimed in claim 13, wherein said security means includes biometric data of said subscriber.

15) The ENUM services system as claimed in claim 11, wherein said financial transaction includes said subscriber accessing their bank accounts either on-line or telephonically, using only said single contact number as identification.

16) The ENUM services system as claimed in claim 11, wherein said financial transaction includes said subscriber performing online or telephonic bill payments with either their financial institution or a commercial entity using only said single contact number to affect payment.

17) An ENUM directory assistance system comprising:
a platform for receiving incoming communications from a caller requesting an incoming contact information of an individual having an ENUM account;
an ENUM directory assistance query platform configured to receive request from said platform for receiving incoming communications such that said ENUM directory assistance query platform searches for said requested incoming contact information from said ENUM account and provides it to said caller.

18) The ENUM directory assistance system as claimed in claim 17, further comprising a server for maintaining ENUM accounts for subscribers.

19) The ENUM directory assistance system as claimed in claim 18, wherein said ENUM directory assistance query platform searches for said requested incoming contact information from said ENUM account in said server for maintaining ENUM accounts.

20) The ENUM directory assistance system as claimed in claim 18, wherein said ENUM directory assistance query platform searches for said requested incoming contact information from said ENUM account in third party ENUM databases.

21) The ENUM directory assistance system as claimed in claim 17, wherein said platform for receiving incoming communications is either one of an automated response module or a live operator module.

22) The ENUM directory assistance system as claimed in claim 21, wherein said platform for receiving incoming communications can receive communications from callers in either one of electronic or telephonic (voice) format.
